(19) United States
(12) Patent Application Publication
(10) Pub. No.: US 2006/0199580 A1
(43) Pub. Date: Sep. 7, 2006

(54) Method of maintaining an initial network selection setting in a wireless local network

(75) Inventor: Wenlin Zhang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/353,471

(22) Filed: Feb. 14, 2006

Related U.S. Application Data
(63) Continuation of application No. PCT/CN04/00943, filed on Aug. 13, 2003.

(30) Foreign Application Priority Data
Aug. 14, 2003 (CN) 03153296.9

(51) Int. Cl. H04Q 7/20

(52) U.S. Cl. 455/432.1; 455/433

(57) ABSTRACT

Disclosed is a method for user equipment (UE) maintaining the setting of initial network selection in a wireless local area network (WLAN). A UE sets and stores an initial network selection in itself when entering a roaming state, and the UE detects and acquires a piece of current time information or a piece of WLAN-associated information. Then, the UE decides according to the change of the acquired time information or WLAN-associated information whether it is necessary to change the setting of the initial network selection. If necessary, the stored initial network selection of the UE is updated. Otherwise, the set initial network selection is kept. In accordance with the disclosed method, the UE is able to make proper and timely selection of a wireless communication network to access when the UE is trying to get accessed via a WLAN that is connected with a plurality of wireless communication networks.

### CROSS-REFERENCES TO RELATED APPLICATIONS

This is a continuation of International Application No. PCT/CN2004/000943, which was filed on Aug. 13, 2004, and which, in turn, claimed the benefit of Chinese Patent Application No. 03153296.9, which was filed on Aug. 14, 2003, the entire disclosures of which are hereby incorporated herein by reference.

### BACKGROUND OF THE DISCLOSURE

1. Field of the Technology

The present invention relates to network accessing techniques and, more specifically, to a method for user equipment (UE) maintaining the setting of initial network selection in a wireless local area network (WLAN).

2. Background of the Invention

At users' demand for an increasingly high rate of wireless access, there emerges WLAN, which is able to provide high-rate wireless data access in a relatively small area. Various techniques have been used in WLAN, among which a technical standard with more applications is IEEE 802.11b. This standard utilizes the frequency band of 2.4 GHz with a data transmission rate up to 11 Mbps. Other technical standards utilizing the same frequency band include IEEE 802.11g and the Bluetooth, where the data transmission rate of IEEE 802.11g is up to 54 Mbps. There are other new standards such as EEE 802.11a and ETSI BRAN Hiperlan2 which use the frequency band of 5 GHz with the transmission rate up to 54 Mbps as well.

Although there are various standards for wireless access, most WLAN are used for transferring IP data packets. The specific WLAN access standard adopted by a wireless IP network is usually transparent to the upper-level IP. Such a network is typically configured with Access Points (AP) for implementing wireless access of UE and with network controlling and connecting devices for implementing IP transmission.

Along with the rising and developing of WLAN, focus of research is shifting to the inter-working of WLAN with various mobile communications networks, such as GSM, CDMA, WCDMA, TD-SCDMA, and CDMA2000. In accordance with the 3GPP standards, UE is able to connect with Internet and Intranet as well as the home network and visited network of a 3GPP system via a WLAN access network. To be specific, when getting accessed locally, a WLAN UE will get connected with the 3GPP home network via a WLAN access network, as shown in FIG. 2; when roaming, it will get connected with a 3GPP visited network via the WLAN access network. Some entities of a 3GPP visited network are connected with corresponding entities of the 3GPP home network, for instance, the 3GPP Authentication, Authorization, Accounting (AAA) proxy in the visited network is connected with the 3GPP AAA server in the home network, the WLAN Access Gateway (WAG) in the visited network is connected with the Packet Data Gateway (PDG) in the home network, as shown in FIG. 1. FIG. 1 and FIG. 2 are the schematic diagrams illustrating the networking architectures of a WLAN inter-working with a 3GPP system under roaming and non-roaming circumstances, respectively.

As shown in FIG. 1 and FIG. 2, a 3GPP system primarily includes Home Subscriber Server (HSS)/ Home Location Register (HLR), 3GPP AAA server, 3GPP AAA proxy, WAG, PDG, Charging Gateway (CGw)/Charging information Collecting Function (CCF), and Online Charging System (OCS). UE, WLAN access network, and all the entities of the 3GPP system together constitute a 3GPP-WLAN inter-working network, which can be regarded as a WLAN service system. In this service system, 3GPP AAA server is in charge of authentication, authorization, and accounting of UE, collecting the charging information sent from the WLAN access network and transferring the information to the charging system; PDG is in charge of transmission of user data from the WLAN access network to the 3GPP network or other packet data networks; and the charging system mainly receives and records the charging information of UE transferred from the network while OCS instructs the network to transmit online charging information periodically in accordance with the expenses of the online charged users, makes statistics and conducts control.

Under non-roaming circumstances, when a WLAN UE desires to get accessed directly to the Internet/Intranet, the UE can access to Internet/Intranet via a WLAN access network after it accomplishes authentication with the AAA server (AS) via the WLAN access network. Should the WLAN UE desire to get accessed to the service of 3GPP packet switched (PS) domain as well, it may further request the service of Scenario 3 from the 3GPP home network. That is, the WLAN UE initiates a service authorization request for Scenario 3 to the AS of the 3GPP home network, which will carry out service authentication and authorization for that request; if the authentication and authorization succeed, AS will send an access accept message to the UE and assign a corresponding PDG for the UE. When a tunnel is established between the UE and the assigned PDG, the UE will be able to get accessed to the service of 3GPP PS domain. Meanwhile, the offline charging system and OCS records the charging information in accordance with the UE's occupation of the network.

Under roaming circumstances, when a WLAN UE desires to get accessed directly to the Internet/Intranet, it may make a request to the 3GPP home network by way of the 3GPP visited network for access to the Internet/Intranet. Should the UE also desire to request the service of Scenario 3 to get accessed to the service of the 3GPP PS domain, the UE needs to initiate via the 3GPP visited network a service authorization process at the 3GPP home network. The authorization is carried out likewise between the UE and AS of the 3GPP home network. After the authorization succeeds, AS assigns the corresponding home PDG for the UE, then the UE will be able to get accessed to the service of 3GPP PS domain of the home network after it establishes a tunnel with the assigned PDG via the WAG of the 3GPP visited network.

As shown in FIG. 3, in a 3GPP-WLAN inter-working network, if a WLAN is connected at the same time with a plurality of 3GPP visited networks, that is, a plurality of wireless communication networks (3GPP visited networks herein refer to Visited Public Land Mobile Networks (VPLMN)), it will be necessary for a WLAN UE to select the desired VPLMN to access after the UE gets accessed to the WLAN. For instance, in China, a WLAN access network may be connected simultaneously with two operating VPLMN, China Mobile and China Unicom; then a user of China Unicom, after getting accessed via the WLAN, has to instruct the WLAN access network to get it accessed to the operating VPLMN of China Unicom.

For another instance, a French user may roam to a WLAN in China, if the home network of the French user has roaming protocols with both China Mobile and China Unicom, then under the circumstances that the WLAN access network is connected with both China Mobile and China Unicom, this French user needs to select the VPLMN to get accessed after accessing the WLAN. At present, under the above circumstances, a WLAN UE will first select the wireless communication network to be accessed currently, then notify the WLAN access network of the selected network by means of the network selection information, where the network selection information may be placed in a field separately configured or placed in the user identity field defined in the format of Network Access Identifier (NAI).

However, if a WLAN UE makes a network selection every time, consumption of network resources would be very high For example, if a user roams away from the local area while the home network of the user is not directly connected with the WLAN access network currently covering the user, in case that the UE always sends to the WLAN access network the information of its own home network as the initial network selection, a network selection procedure would be triggered every time the UE requests to access and the WLAN would issue the information of the wireless communication networks to the UE so that the UE could make a decision and selection before getting accessed, causing consumption of network resources and delay of the user's access. If the wireless communication network selected last time is simply taken as the current selection, it is likely that the currently selected network is not the best PLMN for a WLAN UE which has moved into an area covered by another WLAN. In another word, when a WLAN UE is covered by a new WLAN, this WLAN is likely to connect directly with the Home PLMN (HPLMN) of the UE or other better VPLMN for the UE to access although the default network or the last selected network for the UE to access has a roaming relationship with the home network of this UE. Under these circumstances, it is impossible to make a new network selection of operating network because there has been a default or selected network for the UE to be routed, thus it is impossible to ensure that the UE select the best PLMN connected with the current WLAN, for example, HPLMN. In view of this, a method for optimizing the last network selection has been put forward in another patent application, of which the key idea is: UE decides the network selection information to be carried according to the detected change of WLAN access network or the setting by the user, if there is no change, continue to carry the information of the last successfully accessed network; otherwise take the pre-configured initial selection of network as the network selection information. This method, however, is complicated to implement on the part of UE. Moreover, in some cases, UE may have known which PLMN is desired to be accessed by itself, thus it would be unnecessary to use the above method.

### SUMMARY OF THE INVENTION

In accordance with one aspect of the disclosure, a method is useful for WLAN UE maintaining the setting of initial network selection such that UE is able to make proper and timely selection of wireless communication network to access when the UE is trying to get accessed via a WLAN that is connected with a plurality of wireless communication networks.

In accordance with another aspect of the disclosure, a method for UE maintaining the setting of initial network selection in WLAN includes a UE setting and storing an initial network selection in itself when entering a roaming state, and further includes the steps of:

(A) the UE detecting and acquiring a piece of time information and/or a piece of WLAN-associated information; and

(B) the UE deciding according to a change of the acquired time information and/or a change of the WLAN-associated information whether it is necessary to change the setting of the initial network selection, if necessary, updating the initial network selection of the UE, otherwise, keeping the initial network selection.

The deciding step in step (B) includes the steps of deciding whether the acquired time information indicates that an effective time preset for the initial network selection of the UE has been reached or exceeded, and if the effective time has been reached or exceeded, changing the setting of initial network selection; otherwise, keeping the setting of initial network selection.

The method further includes the steps of storing the WLAN-associated information in the UE. Then the deciding step in step (B) may includes the steps of comparing the currently detected WLAN-associated information with the stored WLAN-associated information in the UE, and if there is no matched information, modifying the setting of initial network selection; otherwise, keeping the setting of initial network selection. Alternatively, the deciding step in step (B) includes the steps of deciding first whether the acquired time information indicates that an effective time preset for the initial network selection of the UE has been reached or exceeded, and if the effective time has been reached or exceeded, changing the setting of initial network selection; otherwise, comparing the currently detected WLAN-associated information with the stored WLAN-associated information in the UE, and if there is no matched information, modifying the setting of initial network selection; otherwise, keeping the setting of initial network selection. Alternatively, the deciding step in step (B) includes the steps of comparing first the currently detected WLAN-associated information with the stored WLAN-associated information in the UE, and if there is no matched information, modifying the setting of initial network selection; otherwise, deciding whether the acquired time information indicates that an effective time preset for the initial network selection of the UE has been reached or exceeded, and if the effective time has been reached or exceeded, changing the setting of initial network selection; otherwise, keeping the setting of initial network selection.

In some cases, the WLAN-associated information includes the Service Set ID (SSID) of the WLAN, or the mobile country code (MCC) to which the WLAN belongs, or the region ID thereof.

In some embodiments, the procedure of updating the setting of initial network selection includes the step of updating the stored initial network selection of the UE to the home network of the UE or the step of updating the stored initial network selection of the UE to null.

The method may further include the step of sending an updating notice to the UE when the initial network selection stored in the UE is updated.

The method may further include the step of sending a prompting message to the UE before the initial network selection stored in the UE is updated.

In accordance with the disclosed method for WLAN UE maintaining the setting of initial network selection, a UE decides according to the change of the currently detected time information or WLAN-associated information whether the effective time has been reached or exceeded or whether the WLAN service area currently covering the UE has changed so as to decide whether to update the initial network selection to the home network of the current UE. This method ensures that WLAN UE make a timely and accurate selection of a proper wireless communication network to access when the UE switches between the roaming and non-roaming states, avoiding repeated selection of wireless communication network every time UE desires to get accessed, reducing the time and number of accesses, and optimizing the accessing procedure of UE. Moreover, the possibility of one-time access is raised, and communication cost is stored to a certain extent when the WLAN has changed, for example, when a user forgets to modify the initial network selection after she/he returns home from a roaming area.

### BRIEF DESCRIPTION OF THE DRAWINGS

FIG. 1 is a schematic diagram illustrating the network architecture of inter-working WLAN system and 3GPP system under roaming circumstances;

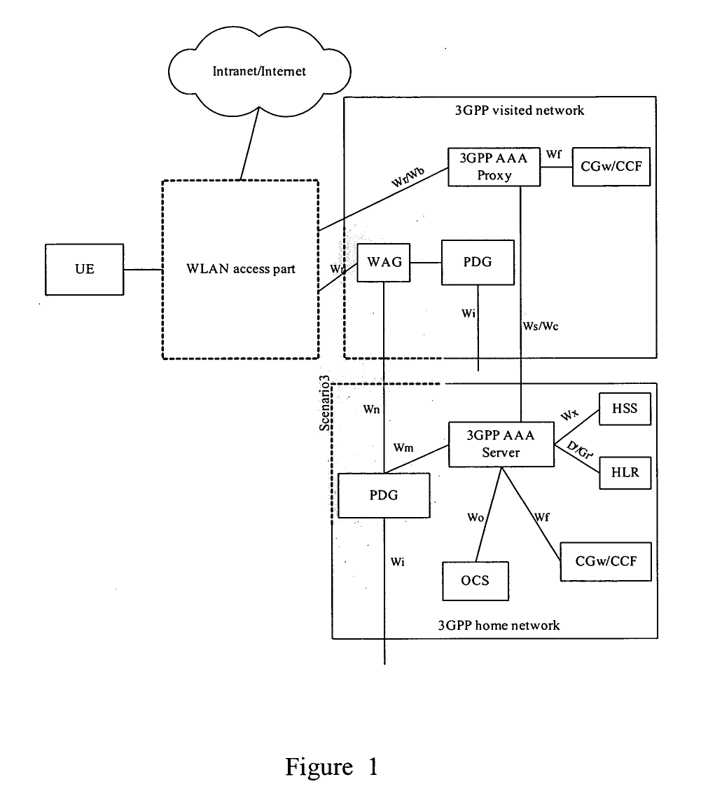

FIG. 2 is a schematic diagram illustrating the network architecture of inter-working WLAN system and 3GPP system under non-roaming circumstances;

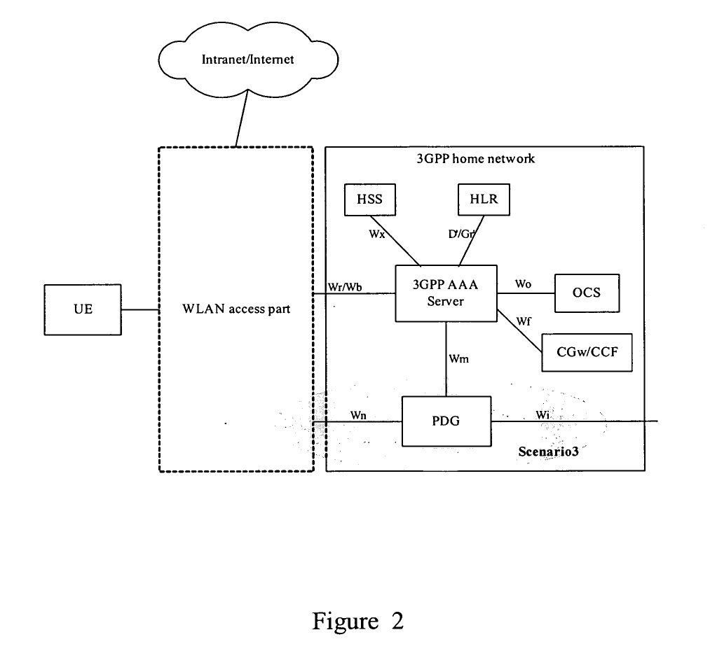

FIG. 3 is a schematic diagram illustrating the network architecture of WLAN connecting with a plurality of visited networks; and

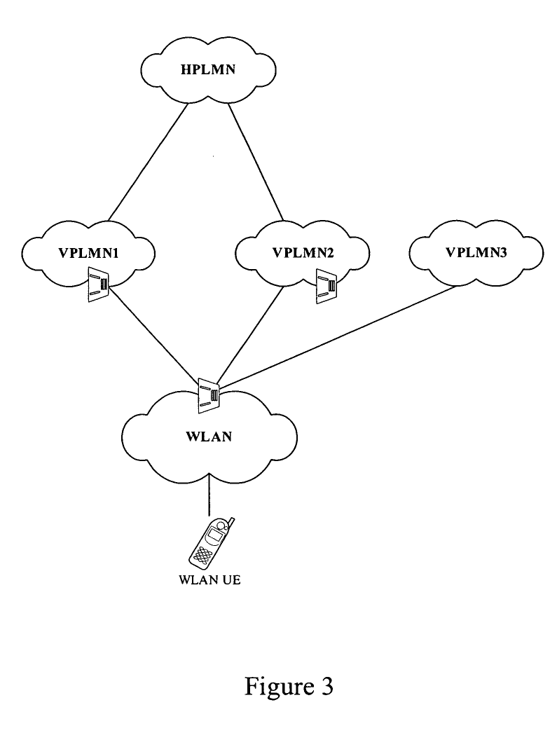

FIG. 4 is a flowchart for updating an initial network selection in accordance with the disclosure.

### DETAILED DESCRIPTION OF PREFERRED EMBODIMENTS

In accordance with one aspect of the disclosed method, a UE decides according to the change of the currently detected time information or WLAN-associated information whether it is necessary to modify the setting of initial network selection, if necessary, updates the initial network selection set in the current UE such that the updated initial network selection would be used for trying the access; otherwise, no updating is made and the set initial network selection would still be used when the selection is required. In this way, it is ensured that, when the WLAN service area currently covering a UE has changed, the UE is able to update in time its own initial network selection, i.e. the information of the wireless communication network with the highest priority for access, thus accessing the best wireless communication network in the fastest way.

The time information here refers to the effective time corresponding to the set initial network information. The WLAN-associated information here refers to the information that can be used for deciding whether the WLAN service area covering the UE has changed, e.g. the SSID of WLAN, or MCC, or region ID.

Every UE usually sets its home network as the initial network selection when the UE is covered by the local networks while, in the roaming state, since the covering WLAN has changed, a user would re-set the initial network selection stored in the UE as the best wireless communication network that is connected with the WLAN covering the UE and has a roaming relationship with the home network of the UE. Therefore, a prerequisite of this embodiment of the disclosed method is that each UE sets its own home network HPLMN as the default initial network selection, and that, when the WLAN has changed, the initial network selection stored in the UE will have been re-set. Furthermore, the initial network selection is used as the network selection information to be carried to the current WLAN access network when the WLAN has changed.

In accordance with the disclosed method, an effective time is set for the initial network selection at the same time of re-setting the initial network selection for the current UE. If the effective time is reached, the initial network selection stored in the current UE will be reset to the home network of this UE so as to ensure that the self-stored initial network selection of the UE could be reset to the home network of this UE when this UE leaves the roaming area, e.g. returns to the local network. When the effective time is reached, various means may be used to inform the user, e.g. displaying a message, playing a prompting tone, etc.

In accordance with this disclosed method, WLAN-associated information and the corresponding wireless communication network with the highest priority to access may be simultaneously stored in UE such that the current UE can decide by comparing the currently detected WLAN-associated information with the stored WLAN-associated information whether it is necessary to reset the initial network selection currently stored in the UE to the home network of this UE. For example, the WLAN-associated information SSID1, SSID3, and SSID8 corresponding to the wireless communication network M1 have been set in UE A as the initial network selection, if the WLAN-associated information currently detected by UE A is SSID2, not any of SSID1, SSID3, and SSID8, UE A will update its own initial network selection to its home network. For another example, the WLAN-associated information MCC1 corresponding to the operating network M2 has been set in UE B as the initial network selection, if the WLAN-associated information currently detected by UE B is MCC2, UE B will update its own initial network selection to its home network. UE may learn that the WLAN has changed, i.e. the SSID or MCC has changed, by various means, for instance, detecting the WLAN broadcasting, detecting other wireless network broadcasting, etc.

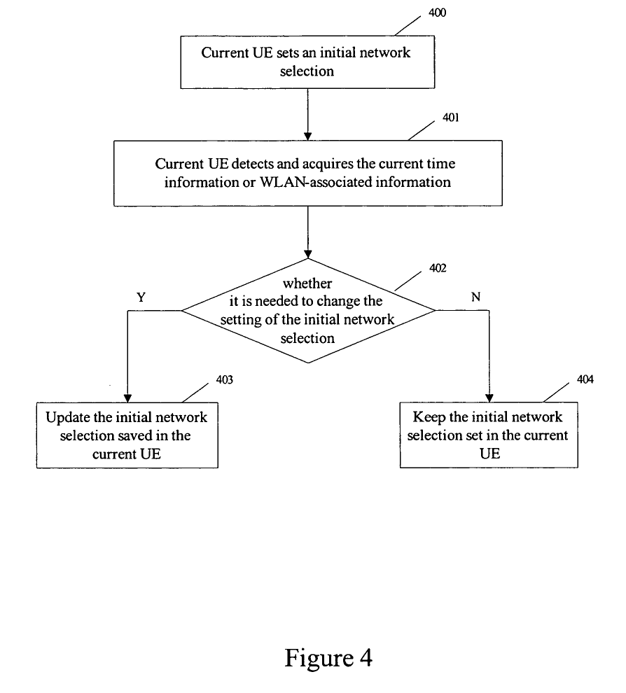

As shown in FIG. 4, the process of updating the initial network selection in accordance with this embodiment includes the steps of:

step 400: the current UE set an initial network selection when entering a roaming state;

step 401: the current UE detects and acquires the current time information or WLAN-associated information; and

steps 402-404: decide according to the change of the detected time information or WLAN-associated information whether it is necessary to change the setting of initial network selection, if necessary, update the initial network selection stored in the current UE; and

otherwise, keep the initial network selection already set in the current UE. Typically, the initial network selection in the UE is updated to the home network of this UE; however, the initial network selection may also be updated to null as required.

It may be decided by the user whether to update the initial network selection in the UE to the home network of the UE, i.e. when the UE detects the change of the WLAN-associated information, a message may be displayed to the user, asking the user whether it is necessary to modify the initial network selection information. If necessary, reset the initial network selection to the home network of the UE, or the user may re-select the setting; otherwise, make no modification. If there is no response from the user for a certain period of time, automatic updating may be carried out as default and then a prompt is displayed to the user.

There are three solutions for implementing the method in accordance with one embodiment of the disclosed method: (1) where only the effective time of the set initial network selection is stored in the UE, then only decide whether the current time has reached the effective time; (2) where only the WLAN-associated information is stored in the UE, then only compare the currently detected WLAN-associated information with the self-stored WLAN-associated information so as to decide whether the WLAN service area covering the UE has changed; (3) the third solution is a combination of the above two, i.e. store simultaneously in the UE the effective time of the set initial network selection and the WLAN-associated information, then decide on the time before comparing the WLAN-associated information, or compare the WLAN-associated information before deciding on the time.

An example is given hereinafter to describe in detail the implementation of the above three solutions, where the home network of subscriber C is China Mobile in China. When subscriber C roams to Britain, it is not covered by China Mobile, but is covered by Vodafone which has a roaming relationship with China Mobile. Thus, the initial network selection in UE C is set to Vodafone and at the same time the effective time thereof is set as five days.

In case of the first solution, if the UE detects that the current time has been the sixth day, i.e. the current time has exceeded the effective time of five days, then reset the initial network selection in UE C to China Mobile.

In case of the second solution, after UE C roams from China to Britain, SSID1, SSID3, or MCC of 44, the WLAN-associated information corresponding to Vodafone will be stored in UE C. If UE C has currently returned to China or roamed to France, UE C will detect that the SSID of the current WLAN is no longer SSID1 or SSID3 or detect that the MCC corresponding to the current WLAN is no longer 44, which means that the WLAN service area covering the UE has changed, then reset the initial network selection in UE C to China Mobile.

In case of the third solution, it is possible to decide first whether the current time has reached 5 days, if the current time has reached 5 days, then reset the initial network selection in UE C to China Mobile; otherwise, decide whether the currently detected WLAN-associated information is matched with one piece of the self-stored WLAN-associated information in the UE C, if matched, no updating is carried out; otherwise, reset the initial network selection in UE C to China Mobile. Alternatively, decide first whether the currently detected WLAN-associated information is matched with one piece of the self-stored WLAN-associated information in the UE C, if not, reset the initial network selection in UE C to China Mobile; otherwise, decide whether the 5-day period has been reached, if the 5-day period has been reached, reset the initial network selection in UE C to China Mobile; if not, no updating is carried out.

The foregoing description is only a preferred embodiment of this invention and is not for use in limiting the protection scope thereof.

1. A method for user equipment (UE) maintaining a setting of an initial network selection in a wireless local area network (WLAN), wherein the UE sets and stores the initial network selection in the UE when entering a roaming state, the method comprising the steps of:
(A) the UE detecting and acquiring time information or WLAN-associated information; and
(B) the UE deciding whether a change of the setting of the initial network selection is necessary according to a change of the acquired time information or a change of the WLAN- associated information, and if necessary, updating the initial network selection in the UE, and otherwise, keeping the setting of the initial network selection.

2. The method according to claim 1, wherein step (B) comprises the steps of deciding whether the acquired time information indicates that an effective time preset for the initial network selection of the UE has been reached or exceeded, and if the effective time has been reached or exceeded, changing the setting of the initial network selection, and otherwise, keeping the setting of the initial network selection.

3. The method according to claim 1, wherein the updating step of step (B) comprises the step of updating the stored initial network selection of the UE to a home network of the UE or the step of updating the stored initial network selection of the UE to null.

4. The method according to claim 1, further comprising the step of storing the WLAN-associated information in the UE.

5. The method according to claim 4, wherein step (B) comprises the steps of comparing currently detected WLAN-associated information with the stored WLAN-associated information in the UE, and if there is no matched information, modifying the setting of the initial network selection, and otherwise, keeping the setting of the initial network selection.

6. The method according to claim 5, wherein the WLAN-associated information comprises a service set ID (SSID) of the WLAN, a mobile country code (MCC) to which the WLAN belongs, or a region ID of the WLAN.

7. The method according to claim 5, wherein the updating step of step (B) comprises the step of updating the stored initial network selection of the UE to a home network of the UE or the step of updating the stored initial network selection of the UE to null.

8. The method according to claim 4, wherein step (B) comprises the steps of deciding first whether the acquired time information indicates that an effective time preset for the initial network selection of the UE has been reached or exceeded, and if the effective time has been reached or exceeded, changing the setting of the initial network selection, and otherwise, comparing currently detected WLAN-associated information with the stored WLAN-associated information in the UE, and if there is no matched information, modifying the setting of the initial network selection, and otherwise, keeping the setting of the initial network selection.

9. The method according to claim 8, wherein the WLAN-associated information comprises a service set ID (SSID) of the WLAN, a mobile country code (MCC) to which the WLAN belongs, or a region ID of the WLAN.

10. The method according to claim 8, wherein the updating step of step (B) comprises the step of updating the stored initial network selection of the UE to a home network of the UE or the step of updating the stored initial network selection of the UE to null.

11. The method according to claim 4, wherein step (B) comprises the steps of comparing first currently detected WLAN-associated information with the stored WLAN-associated information in the UE, and if there is no matched information, modifying the setting of the initial network selection, and otherwise, deciding whether the acquired time information indicates that an effective time preset for the initial network selection of the UE has been reached or exceeded, and if the effective time has been reached or exceeded, changing the setting of the initial network selection, and otherwise, keeping the setting of the initial network selection.

12. The method according to claim 11, wherein the WLAN-associated information comprises a service set ID (SSID) of the WLAN, a mobile country code (MCC) to which the WLAN belongs, or a region ID of the WLAN.

13. The method according to claim 1 1, wherein the updating step of step (B) comprises the step of updating the stored initial network selection of the UE to a home network of the UE or the step of updating the stored initial network selection of the UE to null.

14. The method according to claim 1, further comprising the step of sending an updating notification message to the UE when the initial network selection stored in the UE is updated.

15. The method according to claim 1, further comprising the step of sending a prompting message to the UE before the initial network selection stored in the UE is updated.
